(19) United States
(12) Patent Application Publication
(10) Pub. No.: US 2005/0233707 A1
(43) Pub. Date: Oct. 20, 2005

(54) Mobile phone with health care functionality

(75) Inventor: Ga-Lane Chen, Fremont, CA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD, Tu-cheng City (TW)

(21) Appl. No.: 11/098,096

(22) Filed: Apr. 4, 2005

(30) Foreign Application Priority Data
Apr. 16, 2004 (TW) 93110608

(51) Int. Cl. H01H 35/24

(52) U.S. Cl. 455/90.1; 200/61.01

(57) ABSTRACT

A mobile phone includes a body (11), a vibrating module, a vibration control switch (17), and a function switch (18). The vibrating module is received in the body, and the vibration control switch and the function switch are provided at a surface of the body. The vibration control switch is used to control the vibrating module to turn on or turn off. The function switch is used to control the vibrating module to identify an incoming call or to produce low frequency waves for health care.

### BACKGROUND OF THE INVENTION

1. Field of the Invention

The present invention relates to mobile phones, and particularly to a mobile phone equipped for health care.

2. Description of the Related Art

With the development of the technologies of wireless communication and information processing, mobile phones are now in widespread use. Mobile phones enable consumers to enjoy the convenience of numerous high technology services anytime and anywhere. In addition to general communication functions, many mobile phones also provide extra functions such as Infrared Ray (IR) data transmission, Global Positioning System (GPS) access for security purposes, Internet linkage, games, etc. Worldwide, the number of consumers using mobile phones continues to grow. It is predicted that the mobile phone will become an indispensable personal accessory for almost everyone who can afford it, and that the available functions of a typical mobile phone will continue to multiply.

U.S. Pat. No. 6,428,475 B1 issued on Aug. 6, 2002 provides a mobile phone combined with a physiological function detector. The mobile phone combined with the physiological function detector is represented in FIG. 2 hereof, and includes a mobile phone set 10 and a measurer 20. The measurer 20 is used to contact the skin of a user, and transmit detection signals to the mobile phone set 10 by means of wired or wireless transmission. The measured health data obtained by the mobile phone set 10 can include information such as blood pressure, pulse, etc., and this information is shown in a display 102 of the mobile phone set 10. The data shown in the display 102 may serve to remind the user of his bodily condition. Further, the data may be provided to a physician for historical reference, instead of having to rely on anecdotal statements by the user.

In this context, it is desired to provide a mobile phone with functionality for health care.

### SUMMARY

In preferred embodiments herein, a mobile phone with functionality for health care is provided. The mobile phone includes a body, a vibrating module, a vibration control switch, and a function switch. The vibrating module is received in the body, and the vibration control switch and the function switch are provided at a surface of the body. The vibration control switch is used to control the vibrating module to turn on or turn off. The function switch is used to control the vibrating module to identify an incoming call or to produce low frequency waves for health care.

Other advantages and novel features of the embodiments will become more apparent from the following detailed description thereof when taken in conjunction with the accompanying drawings.

### BRIEF DESCRIPTION OF THE DRAWINGS

FIG. 1 is a plan view of a mobile phone according to a preferred embodiment of the present invention.

FIG. 2 is an isometric view of a conventional mobile phone combined with a physiological function detector.

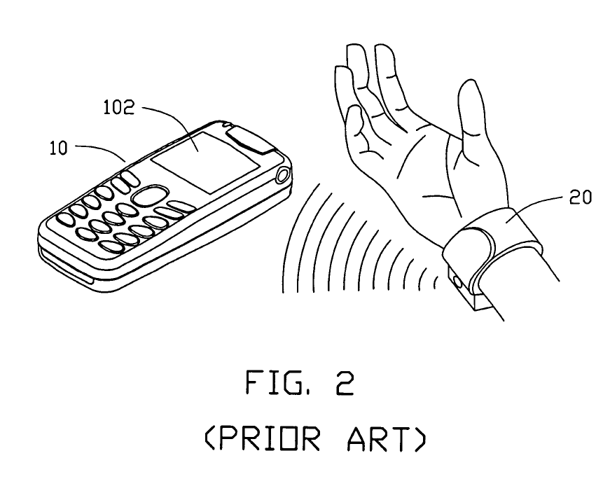

### DETAILED DESCRIPTION OF PREFERRED EMBODIMENTS

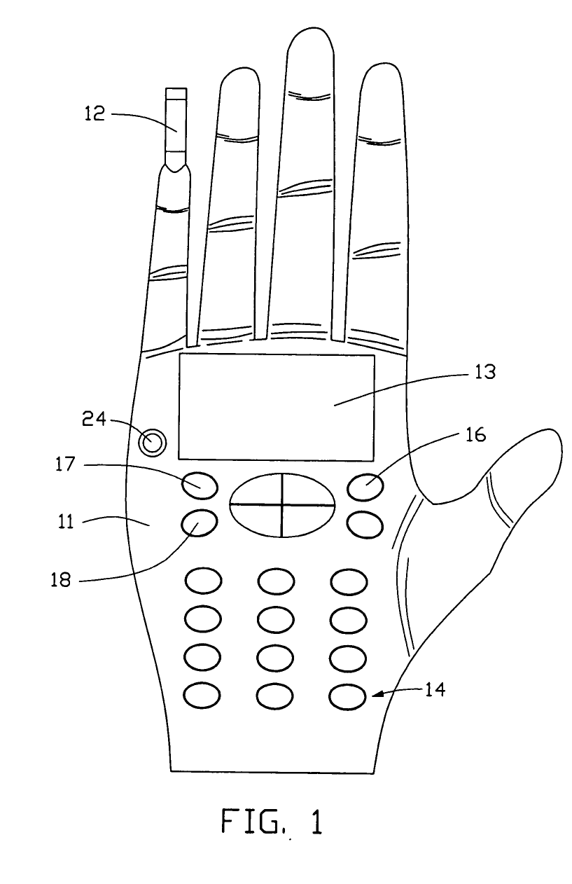

FIG. 1 shows a mobile electronic device like a mobile phone according to a preferred embodiment of the present invention, which is essentially in the form of a glove so as to cover hands of users for establishing a functional interface between the mobile phone and the hands of users. The mobile phone includes a body 11, and a vibrating module (not shown) and a lens module (not shown) received in the body 11.

The body 11 is made of flexible plastic material such as PET (Polyethylene Terephthalate), PC (Polycarbonate), and so on. Such plastic material has good electrical insulation and heat-dispersing characteristics. The body 11 includes an antenna 12, a display 13 and a plurality of buttons and keys. The antenna 12 is formed at a distal end of a little finger of the body 11, and enables wireless communication between the mobile phone and a base station (not shown) of a cellular radiotelephone system. The display 13 and the buttons and keys are formed in the palm of the body 11, with the display 13 being above the buttons and keys. The display 13 is made of flexible E-paper, and may be an electrophoretic display, an OLED (Organic Light-Emitting Diode) display, and so on. The E-paper is highly readable and ergonomically advantageous. The buttons and keys include a power switch 16, a vibration control switch 17, a function switch 18, and a general keypad 14 having a variety of keys below the three switches 16, 17 and 18.

The vibrating module is located in the palm of the body 11, and is electrically coupled with a power supply (not shown) and main circuitry (not shown) of the mobile phone in the body 11. The main circuitry is an FPC (flexible printed circuit). The vibrating module is controlled to turn on or turn off by the power switch 16 and the vibration control switch 17. The function switch 18 is used to control the vibrating module to identify an incoming call or to produce low frequency waves for health care. The vibrating module can produce low frequency waves such as 1 Hz, 2 Hz, 3 Hz, 4 Hz, 5 Hz, 6 Hz, 7 Hz, 8 Hz, 9 Hz, etc. The user can program the mobile phone so that the vibrating module can produce a plurality of low frequency waves with different frequencies. Each pre-identified incoming call or message may be assigned to a particular frequency wave. When the vibrating module is turned on, the frequency of the operative wave is showed in the display 13. The user can change the frequency of the operative wave by using the general keypad 14.

The lens module is located in the palm of the body 11 near the display 13. A cover 24 is provided in the body 11 above the lens module. The cover 24 is a glass board, such as a piece of UV (Ultraviolet) protective glass, for protecting the lens module from outside dust, pollution and temperature extremes.

When the mobile phone according to the preferred embodiment is used as a general mobile phone, the switches 16, 17, and 18 are in a closed state. Generally, the user can identify an incoming call or message by the kind of ring tone sounded by the mobile phone. By pressing the power switch 16 and the vibration control switch 17, the user can identify an incoming call or message by a ring tone, a type of vibration, or a combination thereof. When the user wants to use the mobile phone as an instrument for health care, he/she can wear the glove-shaped mobile phone, and press the function switch 18. The vibrating module is thus turned on to produce low frequency waves. The vibration is helpful to the arteries and veins in the hand, and even beneficially affects entrails in the user's body. For example, waves with a frequency of 1 Hz are helpful to the liver. Similarly, waves with a frequency of 2 Hz are helpful to the kidneys, waves with a frequency of 3 Hz are helpful to the spleen, waves with a frequency of 4 Hz are helpful to the lungs, waves with a frequency of 5 Hz are helpful to the stomach, waves with a frequency of 6 Hz are helpful to the gallbladder, and waves with a frequency of 7 Hz are helpful to the bladder. When the function switch 18 is pressed again, the vibrating module is turned off, and the mobile phone is ready to identify an incoming call or message.

It is to be understood that the vibration control switch 17 may be omitted. Instead, the vibrating module may be controlled by a circuit and one of the keys in the general keypad 14.

It is believed that the present embodiments and their advantages will be understood from the foregoing description, and it will be apparent that various changes may be made thereto without departing from the spirit and scope of the invention or sacrificing all of its material advantages. The examples hereinbefore described are merely preferred or exemplary embodiments of the invention.

1. A mobile phone with health-care functionality, comprising:
a body;
a vibrating module received in the body;
a vibration control switch provided at a surface of the body; and
a function switch provided at a surface of the body;
wherein the vibration control switch controls the vibrating module to turn on or off, and the function switch controls the vibrating module to identify an incoming call or to produce low frequency waves for health care.

2. The mobile phone as claimed in claim 1, wherein the body is essentially in the form of a glove.

3. The mobile phone as claimed in claim 1, wherein the body is made of flexible plastic material selected from the group consisting of Polyethylene Terephthalate and Polycarbonate.

4. The mobile phone as claimed in claim 1, wherein the vibration control member is a vibration control switch.

5. The mobile phone as claimed in claim 1, further comprising a lens module received in the body.

6. The mobile phone as claimed in claim 5, further comprising a cover attached above the lens module.

7. The mobile phone as claimed in claim 1, wherein the body further comprises a display made of flexible E-paper.

8. The mobile phone as claimed in claim 7, wherein the display is an electrophoretic display or an organic light-emitting diode display.

9. The mobile phone as claimed in claim 1, further comprising main circuitry.

10. The mobile phone as claimed in claim 8, wherein the main circuitry comprises a flexible printed circuit.

11. The mobile phone as claimed in claim 1, further comprising a power switch provided at a surface of the body.

12. A mobile electronic device with health-care functionality, comprising:
a body enclosing said mobile electronic device, and providing at least one functional interface approachable and touchable to users of said mobile electronic device; and
a vibrating module installed in said body, and capable of generating at least one of low frequency waves transmitted toward said users via said functional interface so as to cause health-care influence on said users.

13. The mobile electronic device as claimed in claim 12, wherein said body of said mobile electronic device is in a glove form and said at least one functional interface is formed on inner surfaces of said body around hands of said users for hand-touching.

14. The mobile electronic device as claimed in claim 12, wherein said at least one of low frequency waves is available to be used as identification of one of incoming calls and messages transmitted to said mobile electronic device.

15. A method to enable health-care function of a mobile electronic device, comprising the steps of:
providing a user approachable and touchable functional interface on said mobile electronic device;
generating health-care-functional vibration waves; and
transmitting said vibration waves to users of said mobile electronic device via said functional interface.

16. The method as claimed in claim 15, further comprising the step of identifying incoming calls and messages of said mobile electronic device and presetting at least one of said vibration waves in response to identified one of said incoming calls and messages before said transmitting step.
